(19) United States
(12) Patent Application Publication
(10) Pub. No.: US 2015/0145831 A1
(43) Pub. Date: May 28, 2015

(54) PROXIMITY SENSING DEVICE AND METHOD FOR MANUFACTURING THE SAME, AND ELECTRONIC DEVICE

(71) Applicant: Sony Corporation, Tokyo (JP)

(72) Inventors: Kun LI, Beijing (CN); Wenhua LONG, Beijing (CN); Andy LIU, Beijing (CN)

(21) Appl. No.: 14/471,133

(22) Filed: Aug. 28, 2014

(30) Foreign Application Priority Data
Nov. 22, 2013 (CN) 201310597803.5

(51) Int. Cl. G06F 3/042

(52) U.S. Cl. CPC G06F 3/0421
USPC 345/175; 29/428

(57) ABSTRACT

The embodiments of the present invention provide a proximity sensing device and a method for manufacturing the same, and an electronic device. The proximity sensing device includes: a window; a signal transmitting element integrated at an inner side of the window, to transmit an optical signal to an outer side of the window; and a signal sensing element integrated at the inner side of the window and disposed side by side with the signal transmitting element, to sense an object at the outer side of the window by receiving the optical signal reflected by the object. Through the embodiments of the present invention, the gap between the signal transmitting element, the signal sensing element and the window needs not to be considered too much, the integration process becomes easily controllable, and the light leakage is greatly reduced.

### CROSS-REFERENCE TO RELATED APPLICATION

This application claims priority from Chinese patent application No. 201310597803.5, filed Nov. 22, 2013, the entire disclosure of which hereby is incorporated by reference.

### TECHNICAL FIELD

The present invention relates to the field of communication technologies, and particularly, to a proximity sensing device and a method for manufacturing the same, and an electronic device.

### BACKGROUND

With the popularization of electronic devices such as portable smart terminal devices, a proximity sensor is widely applied. Currently, many terminal devices, such as smart phones, have a the proximity sensor mounted therein. For example, the proximity sensor may be located at the upper left corner or the upper right corner at the front side in the housing of the smart phone. The proximity sensor directs an optical signal out through a window of the smart phone, e.g., the window or glass of the smart phone display, and receives light from the window.

The proximity sensor can measure a distance by using the optical signal (e.g., infra-red rays). For example, when a cellular phone user answers a call or places the cellular phone into his pocket, the proximity sensor can judge that the cellular phone adjoins a face or clothes by sensing light reflected by the face or clothes, and then closes a touch control function, thereby preventing a misoperation, and closing a display screen and backlight for a power saving.

To be noted, the above introduction to the technical background is just made for the convenience of clearly and completely describing the technical solutions of the present invention, and to facilitate the understanding of a person skilled in the art. It shall not be deemed that the above technical solutions are known to a person skilled in the art just because they have been illustrated in the Background section of the present invention.

### SUMMARY

However, the inventor finds that in the relevant art, the proximity sensor is mounted or assembled on the PCB, (sometimes referred to as “integrated on” the PCB). The PCB is assembled in the electronic device so as to align the proximity sensor in relation to the window of the electronic device, for example, the window or glass of or associated with the display of the electronic device, to direct light out through the window and to receive light from the window. There may be a gap between the signal transmitting element (e.g., infrared light-emitting diode (IR LED)), the signal sensing element (e.g., photo diode) and the window, which should be considered in operation of the proximity sensor. The gap is related to a manufacturing tolerance and an assembling tolerance of components and structural members of the electronic device. It is difficult to control an assembling process of the electronic device while minimizing or eliminating the gap. In addition, if the gap between the signal transmitting element, the signal sensing element and the window is too large, a light leakage may occur, i.e., the light from the signal transmitting element is reflected to the signal sensing element by an inner surface of the window, and a detection result of the proximity sensor becomes inaccurate.

The embodiments of the present invention provide a proximity sensing device and a method for manufacturing the same, and an electronic device, through which the gap between the signal transmitting element, the signal sensing element and the window needs not to be considered too much, the assembling process becomes easily controllable, and the light leakage is greatly reduced.

According to a first aspect of the embodiments of the present invention, a proximity sensing device is provided, including:

a window;

a signal transmitting element, integrated at, e.g., arranged on, assembled on or mounted to, an inner side of the window, to transmit an optical signal to an outer side of the window; and

a signal sensing element, integrated at, e.g., arranged on, assembled on or mounted to, the inner side of the window and disposed side by side with the signal transmitting element, to sense an object at the outer side of the window by receiving the optical signal reflected by the object.

According to a second aspect of the embodiments of the present invention, wherein pads are arranged on surfaces of the signal transmitting element and the signal sensing element for attachment to the window, and the signal transmitting element and the signal sensing element are bonded on the inner surface of the window by using the pads.

According to a third aspect of the embodiments of the present invention, wherein the signal transmitting element and the signal sensing element have pins attached to the window, respectively, and signal lines of the signal transmitting element and the signal sensing element are connected to circuit paths or traces that are on the window via the pins.

According to a fourth aspect of the embodiments of the present invention, wherein the pins are welded to the surface of the window using an Anisotropic Conductive Film (ACF) bonding technology.

According to a fifth aspect of the embodiments of the present invention, wherein the window includes a Sensor On Lens (SOL) configuration or structure, and the signal lines of the signal transmitting element and the signal sensing element are connected to the SOL via the pins.

According to a sixth aspect of the embodiments of the present invention, wherein the proximity sensing device further includes:

a printed circuit board, disposed at sides of the signal transmitting element and the signal sensing element opposite the window.

According to a seventh aspect of the embodiments of the present invention, wherein signal lines of the signal transmitting element and the signal sensing element are connected to the printed circuit board.

According to an eighth aspect of the embodiments of the present invention, an electronic device is provided, including the aforementioned proximity sensing device.

According to a ninth aspect of the embodiments of the present invention, a method for manufacturing a proximity sensing device is provided, including:

providing a window;

arranging a signal transmitting element on an inner side of the window in position to direct optical signal to the window for transmission through the window to an outer side of the window; and

arranging a signal sensing element on the inner side of the window in side by side relation with the signal transmitting element to sense an object at the outer side of the window by receiving the optical signal reflected by the object.

According to a tenth aspect of the embodiments of the present invention, wherein the method further includes:

arranging pads on the surfaces of the signal transmitting element and the signal sensing element for connection to the window, and bonding the signal transmitting element and the signal sensing element on the inner surface of the window by using the pads.

According to an eleventh aspect of the embodiments of the present invention, wherein the signal transmitting element and the signal sensing element have pins attached to the window, respectively, and signal lines of the signal transmitting element and the signal sensing element are connected to the window via the pins.

According to a twelfth aspect of the embodiments of the present invention, wherein the window includes a Sensor On Lens (SOL), the method further including:

welding the pins to the surface of the window using an Anisotropic Conductive Film (ACF) bonding technology, wherein the signal lines of the signal transmitting element and the signal sensing element are connected to the SOL via the pins.

The embodiments of the present invention have the following beneficial effect: by integrating, e.g., arranging, mounting or attaching, the signal transmitting element and the signal sensing element at the inner side of the window, the gap between the signal transmitting element, the signal sensing element and the window is reduced or eliminated to the extent that it need not be considered or requires less consideration in operation of the proximity sensor, the assembly process becomes easily controllable, and the light leakage is greatly reduced.

These and other aspects of the present invention will be clear with reference to the subsequent descriptions and drawings, which disclose embodiments of the present invention to indicate some implementations of the principles of the present invention. But it shall be appreciated that the scope of the present invention is not limited thereto, and the present invention includes all the changes, modifications and equivalents falling within the scope, spirit and connotations of the accompanied claims.

Features described and/or illustrated with respect to one embodiment can be used in one or more other embodiments in a same or similar way, and/or by being combined with or replacing the features in other embodiments.

To be noted, the term “comprise/include” used herein specifies the presence of feature, element, step or component, not excluding the presence or addition of one or more other features, elements, steps or components or combinations thereof.

Many aspects of the present invention will be understood better with reference to the following drawings. The components in the drawings are not necessarily drafted in proportion, and the emphasis lies in clearly illustrating the principles of the present invention. For the convenience of illustrating and describing some portions of the present invention, corresponding portions in the drawings may be enlarged, e.g., being more enlarged relative to other portions than the situation in the exemplary device practically manufactured according to the present invention. The parts and features illustrated in one drawing or embodiment of the present invention may be combined with the parts and features illustrated in one or more other drawings or embodiments. In addition, the same reference signs denote corresponding portions throughout the drawings, and they can be used to denote the same or similar portions in more than one embodiment.

### BRIEF DESCRIPTION OF THE DRAWINGS

The included drawings provide further understanding of the present invention, and they constitute a part of the Specification. The drawings illustrate the preferred embodiments of the present invention, and illustrate principles of the present invention together with the text, wherein the same element is always denoted with the same reference sign.

In the drawings:

FIG. 1 is a schematic diagram of an integrated proximity sensor in the relevant art with a relatively small gap T;

FIG. 2 is another schematic diagram of an integrated proximity sensor in the relevant art with a relatively large gap T;

FIG. 3 is a structure diagram of a proximity sensing device according to an embodiment of the present invention;

FIG. 4 is another structure diagram of a proximity sensing device according to an embodiment of the present invention;

FIG. 5 is another structure diagram of a SOL structure according to an embodiment of the present invention;

FIG. 6 is a structure diagram of a SOL structure arranged on a window according to an embodiment of the present invention;

FIG. 7 is another structure diagram of a proximity sensing device according to an embodiment of the present invention;

FIG. 8 is another structure diagram of a proximity sensing device according to an embodiment of the present invention;

FIG. 9 is a flowchart of a method for manufacturing a proximity sensing device according to an embodiment of the present invention; and

FIG. 10 is a block diagram of a system structure of an electronic device according to an embodiment of the present invention.

### DESCRIPTION OF THE EMBODIMENTS

The interchangeable terms “electronic device” and “electronic apparatus” include a portable radio communication device. The term “portable radio communication device”, which is hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, portable communication apparatus, etc.

In the present application, the embodiments of the present invention are mainly described with respect to a portable electronic apparatus in the form of a mobile phone (also referred to as “cellular phone”). However, it shall be appreciated that the present invention is not limited to the case of the mobile phone and it may relate to any type of appropriate electronic device, such as media player, gaming device, PDA, computer, digital camera, tablet computer, etc.

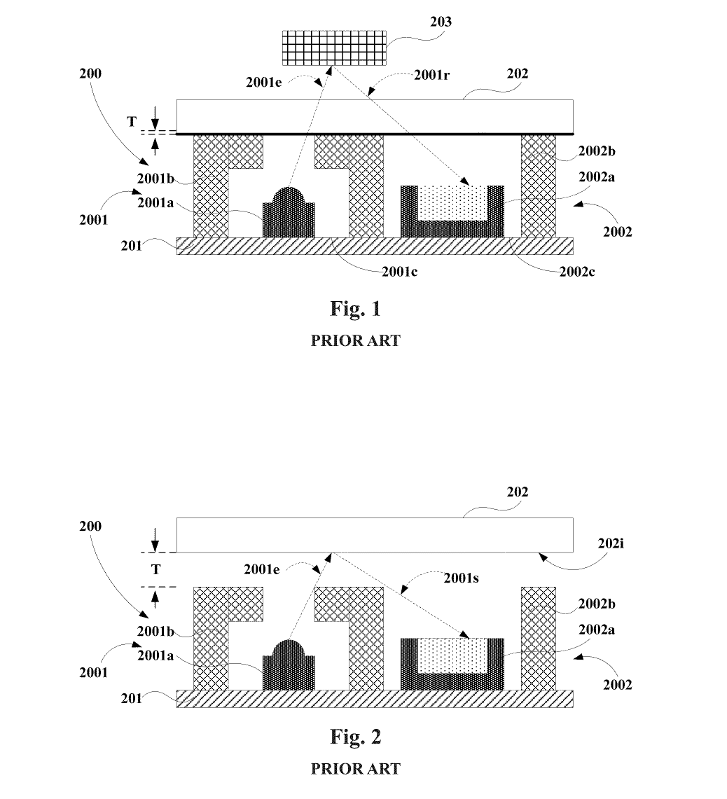

FIG. 1 is a schematic diagram of an integrated proximity sensor 200 in the relevant art. As illustrated in FIG. 1, a signal transmitting element 2001 (includes e.g., an infrared light-emitting diode (IR LED) 2001a) and a signal sensing element 2002 (includes e.g., a photo diode 2002a) are arranged on or mounted on a printed circuit board 201, e.g., by welding, soldering or otherwise securely attaching to the printed circuit board. The signal transmitting element 2001 is surrounded by a sealing element 2001b (e.g., rubber) to prevent light leakage. The signal sensing element 2002 is surrounded by a sealing element 2002b (e.g., rubber) to prevent light leakage.

In addition, a window 202 is provided above the signal transmitting element 2001 and the signal sensing element 2002. The signal lines or terminals (not illustrated) of the signal transmitting element 2001 and the signal sensing element 2002 are connected to the printed circuit board 201, e.g., electrically connected to printed circuit traces or terminals of the printed circuit board, thereby to provide for power, control and sensed signals for operation of the proximity sensor.

As illustrated in FIG. 1, the signal transmitting element 2001 emits, for example, IR rays 2001e that are transmitted through the window 202. If there is an object 203 (e.g., face) outside the window 202, the IR rays may be reflected by the object 203 as reflected rays 2001r to be received by the signal sensing element 2002 and thereby the existence of the object 203 is sensed.

Since the signal transmitting element 2001 and the signal sensing element 2002 are welded, soldered or otherwise attached (the term “welded” may include any of these attachments) on the printed circuit board 201, it is necessary to consider a gap T between the signal transmitting element 2001, the signal sensing element 2002 and the window 202. But it is difficult to accurately adjust or control the gap T, e.g., due to the above-mentioned tolerances needed for manufacturing or assembling parts of the electronic device so it will be appreciated that the assembling process of the proximity sensor in the electronic device cannot be easily controlled.

FIG. 2 is another schematic diagram of an integrated proximity sensor 200 in the relevant art. As illustrated in FIG. 2, if the gap T between the signal transmitting element 2001, the signal sensing element 2002 and the window 202 is too large, the IR rays 2001e emitted from the signal transmitting element 2001 may be directly reflected at the inner side 202i of the window 202 as reflected rays 2001s and then received by the signal sensing element 2002. The reflected rays 2001s occur due to a light leakage in the gap T, and the detection result of the proximity sensor 200 becomes inaccurate. The extent of such inaccuracy may depend on the size of the gap T, e.g., from relatively small if the gap is small as in FIG. 1 to relatively larger if the gap is larger as in FIG. 2.

Therefore, the proximity sensor at present has a problem that the assembling process cannot be easily controlled, and the light leakage often occurs, thus the detection result of the proximity sensor becomes inaccurate. To be noted, the proximity sensor is just exemplarily described as above, and please refer to the relevant art for other technical details of the proximity sensor.

### Embodiment 1

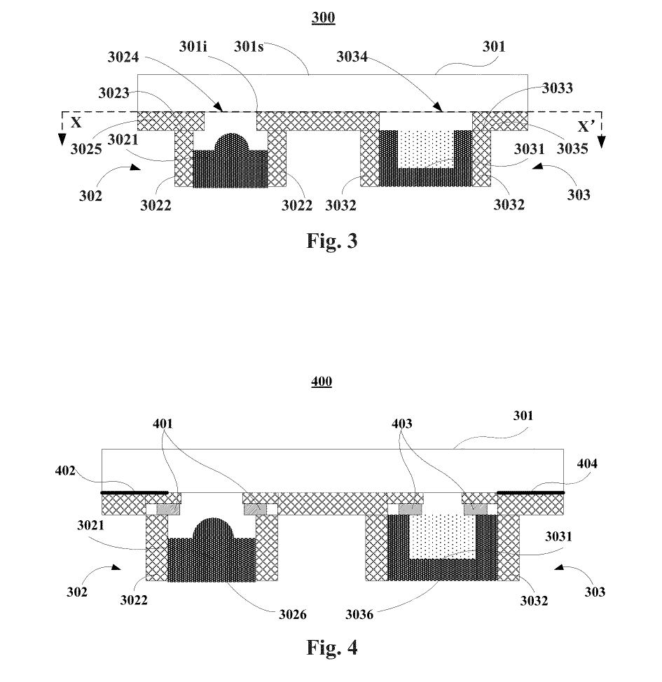

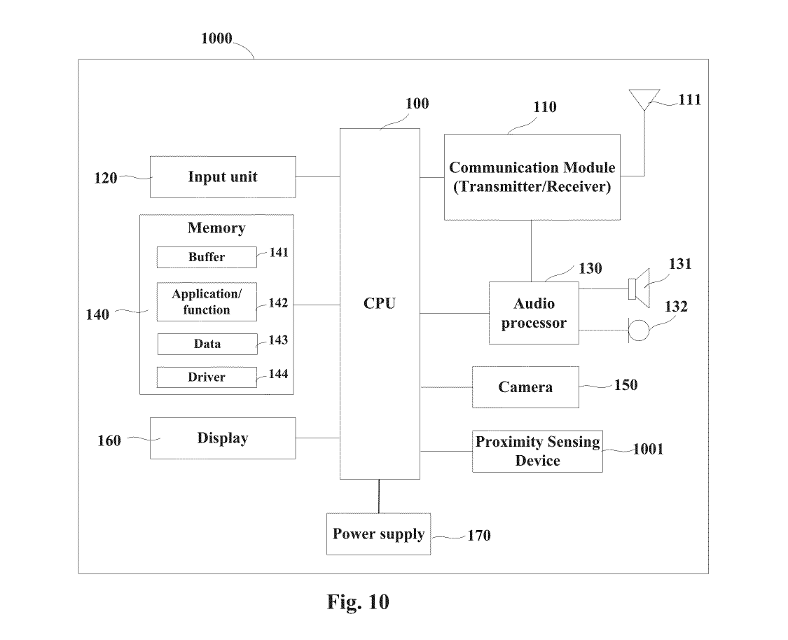

FIG. 3 is a structure diagram of a proximity sensing device 300 according to an embodiment of the present invention. The proximity sensing device 300 may be used, for example, in the electronic device 1000 shown in FIG. 10 or in another electronic device, etc. As illustrated in FIG. 3, a proximity sensing device 300 includes:

a window 301;

a signal transmitting element 302 arranged on an inner side 301i of the window 301, to transmit an optical signal through an outer side 301s of the window 301; and

a signal sensing element 303 arranged on the inner side 301i of the window 301 and disposed side by side with the signal transmitting element 302, to sense an object which is out of the outer side 301s of the window 301 by receiving the optical signal reflected by the object.

This embodiment differs from the relevant art in that the signal transmitting element 302 and the signal sensing element 303 are assembled at the inner side 301i of the window 301. For example, the signal transmitting element 302 and the signal sensing element 303 may be mounted on, attached to, etc. the window 301 as to be seamlessly connected to or seamlessly assembled on the window. Thus the gap between the signal transmitting element, the signal sensing element and the window may be reduced or non-existent and need not to be considered in operation of the proximity device 300. Also, the assembling process becomes easily controllable, and the light leakage is greatly reduced.

In this embodiment, the window 301 may serve as a part of the electronic device, such as a part of the display screen. The inner side 301i of the window 301 may be one side of the electronic device, e.g., the electronic device 1000 shown in FIG. 10 or other electronic device, as is mentioned elsewhere herein, too, and the signal transmitting element 302 and the signal sensing element 303 assembled (the term “assembled” refers to being mounted, attached, and so on as is described also elsewhere herein) at the inner side of the window are located inside the electronic device. For a person skilled in the art, the inner side 301i or the outer side 301s of the window 301 is clear, and the specific direction may be determined according to the actual situation.

As shown in FIG. 3, the signal transmitting element 302 may include, for example, an infrared light-emitting diode 3021, and the signal sensing element 303 may include, for example, a photo diode 3031.

The signal transmitting element 302 may be surrounded on its sides by a housing or gasket member 3022, which may be rubber, plastic or other material that blocks light and can hold the signal transmitting element therein, e.g., in position in the proximity sensing device. The top edge 3023 of the member 3022 may conform to the inner side 301i of the window 301 or to a coating or other material, e.g., printed circuit traces, to facilitate attaching the signal transmitting element 302 to the window 301, e.g., using adhesive or some other technique as described herein or otherwise may be available. An open area 3024 permits light from the light transmitting element 302 to pass to impinge on the window 301 while the member 3022 blocks light leakage. A coating 3025 on part of the window 301 may be provided to block light from leaking in a lateral direction to the inner side 301i of the window 301.

The signal sensing element 303 may also be surrounded on its sides by a housing or gasket member 3032. which may be rubber, plastic or other material that blocks light and can hold the signal sensing element therein, e.g., in position in the proximity sensing device. The top edge 3033 of the member 3032 may conform to the inner side 301i of the window 301 or to a coating or other material, e.g., printed circuit traces, to facilitate attaching the signal transmitting element 302 to the window 301, e.g., using adhesive or some other technique as described herein or otherwise may be available. An open area 3034 permits light to pass from the window 301 to the signal sensing element 303, while the member 3032 blocks light leakage. A coating 3035 on part of the window 301 may be provided to block light from leaking in a lateral direction to the inner side 301i of the window 301.

In this embodiment, the signal transmitting element 302 and the signal sensing element 303 may be assembled and located side by side (e.g., substantially in parallel) at the inner side 301i of the window 301. The signal transmitting element 302 and the signal sensing element 303 may be bonded on the window 301 by using adhesives. Alternatively or additionally they may be bonded on the window 301 by using pads that are attached to the signal transmitting element and the signal sensing element and may be welded, soldered or otherwise attached to the window. The present invention is not limited thereto, and the assembling and/or attaching to the window may be performed in other ways.

In this embodiment, the signal transmitting element 302 may emit IR rays, but the present invention is not limited thereto, and other optical signal may also be emitted. In addition, a printed circuit board (not illustrated in FIG. 3) may be disposed below the signal transmitting element 302 and the signal sensing element 303. Please refer to the relevant art for the specific content of the printed circuit board in the proximity sensing device.

In one embodiment, the signal transmitting element and the signal sensing element may have pins attached to the window, respectively, for electrical connection to conductors on the window and/or to mechanically attach the signal transmitting element and the signal sensing element to the window. The signal lines of the signal transmitting element and the signal sensing element are connected to the conductors on the window inner side via the pins.

FIG. 4 is another structure diagram of a proximity sensing device 400 according to an embodiment of the present invention. As illustrated in FIG. 4, the proximity sensing device 400 includes the window 301, the signal transmitting element 302 and the signal sensing element 303 as described above.

As illustrated in FIG. 4, the signal transmitting element 302 may have a pin 401 connected to the window 301, and a signal line 402 of the signal transmitting element 302 is connected to the window side via the pin 401. The signal sensing element 303 may have a pin 403 connected to the window 301, and a signal line 404 of the signal sensing element 303 is connected to the window side via the pin 403. It is noted that the pin 401 and the pin 403 each may be more than one pin; and the signal line 402 and the signal line 404 each may be more than one signal line.

For example, an end of the signal line 402 is electrically connected to the CPU 100 and/or the power supply 170 of the electronic device 1000 shown in FIG. 10, the other end of the signal line 402 is electrically connected to the pin 401 (the connection is not illustrated in FIG. 4 for the sake of simplicity), thereby to provide for power, control and sensed signals for operation of the signal transmitting element 302.

Likewise, an end of the signal line 404 is electrically connected to the CPU 100 and/or the power supply 170 of the electronic device 1000 shown in FIG. 10, the other end of the signal line 404 is electrically connected to the pin 403 (the connection is not illustrated in FIG. 4 for the sake of simplicity), thereby to provide for power, control and sensed signals for operation of the signal sensing element 303.

In this embodiment, the window 301 may be integrated with a Sensor On Lens (SOL), which is also referred to as One Glass Solution (OGS) and which adopts Chip On Glass (COG). The present invention is not limited thereto, and herein the SOL is just described as an example. Please refer to the relevant art for the content about forming a circuit on the window. In addition, the sensor hub may be processed. For example, the proximity sensor may be controlled using extra pins in the SOL. Please refer to the relevant art for the details of the sensor hub.

For example, a SOL configuration or structure is included in the window 301. Some pins (or terminals, or lines) in the SOL may not be used, so the signal transmitting element 302 and the signal sensing element 303 may be electrically connected to the SOL via the extra pins (or terminals, or lines). These connections provide for power, control and sensed signals for operation of the signal transmitting element 302 and the signal sensing element 303 via the SOL included in the window, instead of directly connecting to the CPU 100 and/or the power supply 170 of the electronic device 1000 shown in FIG. 10.

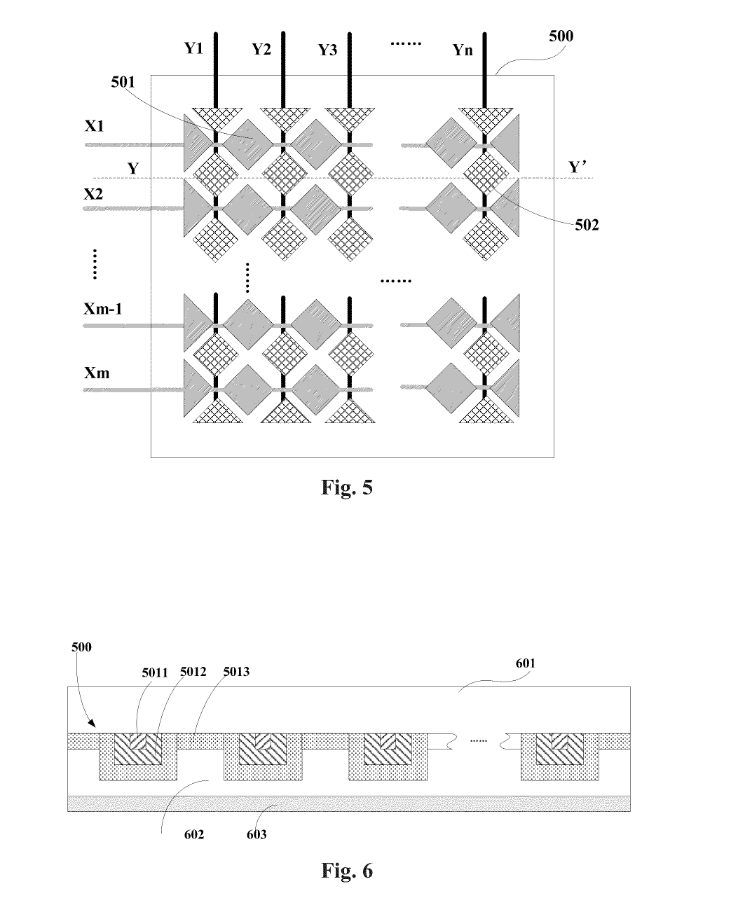

FIG. 5 is another structure diagram of a SOL structure according to an embodiment of the present invention. As shown in FIG. 5, there are some diamond bridge patterns 501 and 502 in the SOL structure 500. As shown in FIG. 5, there are some lines (such as line X1, X2, Xm, and Y1, Y2, . . . , Yn) in the SOL structure 500. For example, line X1 may be used to electrically connect with the signal transmitting element 302, and line X2 may be used to electrically connect with the signal sensing element 303.

FIG. 6 is a structure diagram of a SOL structure integrated on a window according to an embodiment of the present invention. It shows a schematic cross-section view along line YY′ in FIG. 5. The SOL structure 500 is arranged on the window 601. As shown in FIG. 6, there are some elements (such as sputtered and patterned bridge 5011, coated insulator 5012, sputtered and patterned X-Y sensor 5013) in the SOL structure 500. Furthermore, there are some elements (such as hard coating pet (HC-PET) 602, optical clear adhesive (OCA) 603) under the SOL structure 500.

It should be noted that the FIG. 5 and FIG. 6 are examples of the SOL structure, the SOL is just exemplarily described as above, but it is not limited thereto.

In this embodiment, the encapsulations and pad positions of the signal transmitting element and the signal sensing element may be redesigned. The pads may be encapsulated on the upper surfaces of the signal transmitting element and the signal sensing element, such that the signal transmitting element and the signal sensing element are bonded on the inner surface of the window by using the pads. In addition, the components (e.g., pins) may be welded to the circuit on the glass surface using an Anisotropic Conductive Film (ACF) bonding technology, but the present invention is not limited thereto.

For example, the signal transmitting element and the signal sensing element may be encapsulated by a housing or gasket member, such as rubber. In the relevant art, the pads may be arranged under the signal transmitting element and the signal sensing element, e.g., the pads may be arranged on a lower side 2001c of the signal transmitting element 2001 and a lower side 2002c of the signal sensing element 2002, as shown in FIG. 1. Thereby the signal transmitting element and the signal sensing element is assembled on the printed circuit board.

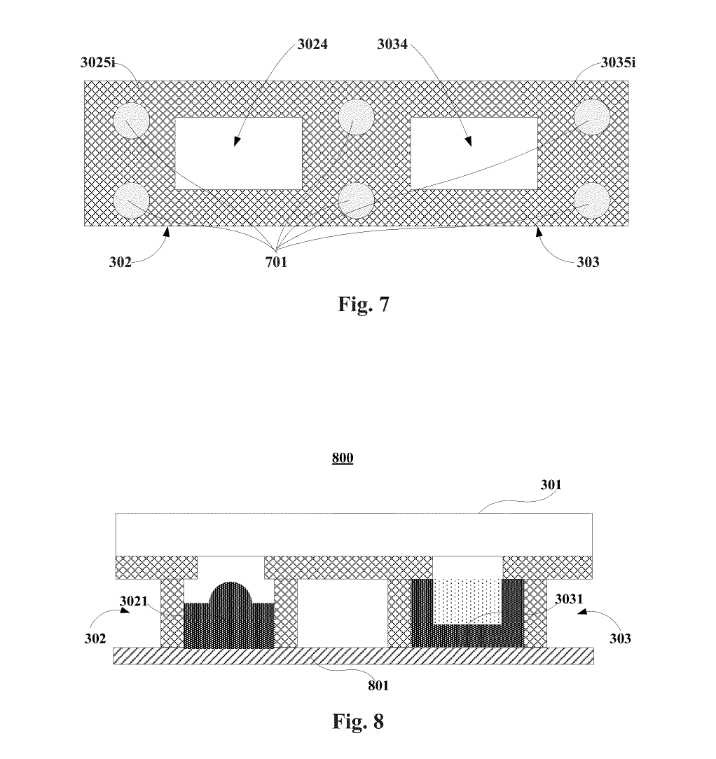

However, in this embodiment, the pad positions of the signal transmitting element and the signal sensing element may be redesigned, the pads may be arranged above the signal transmitting element and the signal sensing element, for example, the pads may be arranged on the upper side 3025i of the coating 3025 and the upper side 3035i of the coating 3035, as shown in FIG. 7. Thereby the encapsulations of the signal transmitting element and the signal sensing element may be redesigned, and pad positions may also be redesigned. The signal transmitting element and the signal sensing element is assembled on the inner surface of the window.

FIG. 7 is another structure diagram of a proximity sensing device 300 according to an embodiment of the present invention, it shows a schematic cross-section view along line XX′ in FIG. 3. As illustrated in FIG. 7, there are some pads 701 on the upper sides of the signal transmitting element 302 and the signal sensing element 303, such that the signal transmitting element 302 and the signal sensing element 303 are assembled on the inner surface of the window 301 by using the pads 701.

In this embodiment, the signal lines of the signal transmitting element and the signal sensing element may be connected to a circuit at the window side via the pins. The signal line 402 of the signal transmitting element 302 may be connected to the SOL circuit of the window 301 via the pin 401, and the signal line 404 of the signal sensing element 303 may be connected to the SOL circuit of the window 301 via the pin 403. Thus, the line design can be simplified to achieve the effects of optimizing the lines and improving the reliability.

In another embodiment, the signal lines of the signal transmitting element and the signal sensing element may be connected to the printed circuit board side. The printed circuit board (not shown in FIG. 4) is disposed at the other side 3026 of the signal transmitting element 302 and the other side 3036 of the signal sensing element 303 opposite the window 301.

FIG. 8 is another structure diagram of a proximity sensing device according to an embodiment of the present invention. As illustrated in FIG. 8, a proximity sensing device 800 includes the window 301, the signal transmitting element 302 and the signal sensing element 303 as described above.

As illustrated in FIG. 8, the proximity sensing device 800 further includes a printed circuit board 801 disposed below the signal transmitting element 302 and the signal sensing element 303. As illustrated in FIG. 8, the signal transmitting element 302 and the signal sensing element 303 either has one end assembled at the inner side of the window 301, and the other end disposed on the printed circuit board 801. The signal lines of the signal transmitting element 302 and the signal sensing element 303 are connected to the printed circuit board 801 (the connection is not shown in FIG. 8). Thus, the line design in the relevant art can be reused to reduce the cost.

To be noted, FIGS. 3-8 only schematically illustrate some compositions of the proximity sensing device, and some portions (e.g., adhesive, gasket, etc.) are omitted for simplicity. In addition, the connection of the signal lines is also not completely illustrated. The present invention is not limited thereto, and a person skilled in the art can obtain the complete technical solution according to the drawings.

As can be seen from the above embodiment, by assembling or mounting the signal transmitting element and the signal sensing element at the inner side of the window, the gap between the signal transmitting element, the signal sensing element and the window may be eliminated or may be sufficiently reduced in size so that its effect on operation of the proximity sensor is reduced and even may not have to be considered. Also, the assembling process becomes more easily controllable, and the light leakage is greatly reduced.

Further, the signal lines of the signal transmitting element and the signal sensing element are connected to the window side via the pins, thus the line design can be simplified to achieve the effects of optimizing the lines and improving the reliability.

### Embodiment 2

The embodiment of the present invention provides a method for manufacturing a proximity sensing device. The proximity sensing device may be as illustrated in Embodiment 1, and the same contents are omitted herein.

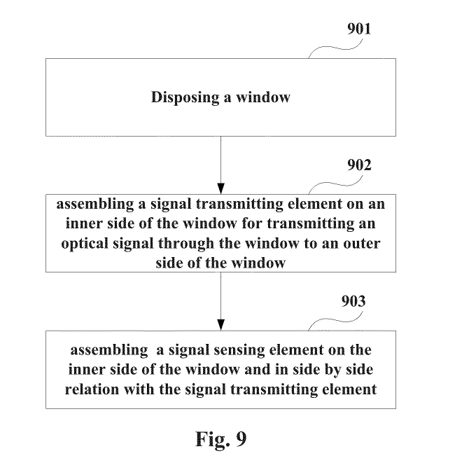

FIG. 9 is a flowchart of a method for manufacturing a proximity sensing device according to an embodiment of the present invention. As illustrated in FIG. 9, the manufacturing method includes:

Step 901: disposing a window;

Step 902: assembling, e.g., mounting, attaching, securing, etc., a signal transmitting element on an inner side of the window for transmitting an optical signal through the window to an outer side of the window;

Step 903: assembling, e.g., mounting, attaching, securing, etc., a signal sensing element on the inner side of the window and in side by side relation with the signal transmitting element, the signal sensing element being positioned and configured to sense an object at the outer side of the window by receiving the optical signal reflected by the object.

In one embodiment, the signal transmitting element and the signal sensing element may have pins integrated to the window, respectively. The signal lines of the signal transmitting element and the signal sensing element are connected to the window side via the pins.

In another embodiment, the manufacturing method may include: disposing a printed circuit board below the signal transmitting element and the signal sensing element; and connecting the signal lines of the signal transmitting element and the signal sensing element to the printed circuit board.

As can be seen from the above embodiment, by assembling the signal transmitting element and the signal sensing element at the inner side of the window, the gap between the signal transmitting element, the signal sensing element and the window needs not to be considered at all or at least is of reduced consideration in operation of the proximity sensor. Also, the integration process becomes easily controllable, and the light leakage is greatly reduced.

### Embodiment 3

The embodiment of the present invention provides an electronic device, including the proximity sensing device according to Embodiment 1. The electronic device may be, but not limited to, a mobile terminal, and herein the mobile terminal is just described as an example.

FIG. 10 is a block diagram of a system structure of an electronic device 1000 according to an embodiment of the present invention, including a proximity sensing device 1001 which may be as described in Embodiment 1.

In this embodiment, the proximity sensing device 1001 of the electronic device 1000 may include:

a window;

a signal transmitting element assembled, mounted, etc. on an inner side of the window, to transmit an optical signal to the window; and

a signal sensing element assembled, mounted, etc. on the inner side of the window and disposed side by side with the signal transmitting element, to sense an object at the outer side of the window by receiving the optical signal reflected by the object.

In one embodiment, the signal transmitting element and the signal sensing element may have pins integrated to the window, respectively. The signal lines of the signal transmitting element and the signal sensing element are connected to the window side via the pins.

In another embodiment, the proximity sensing device 1001 of the electronic device 1000 may further include: a printed circuit board disposed below the signal transmitting element and the signal sensing element, and the signal lines of the signal transmitting element and the signal sensing element are connected to the printed circuit board.

As illustrated in FIG. 10, the electronic device 1000 may further include a central processing unit (CPU) 100 and a memory 140. The CPU 100 (sometimes referred to as controller or operation control, including microprocessor or other processor device and/or logic device) receives an input and controls respective parts and operations of the electronic device 1000. The CPU 100 may control the proximity sensing device 1001 to realize the function of proximity detection.

The memory 140 is coupled to the CPU 100. The memory 140 may be a solid state memory, such as Read Only Memory (ROM), Random Access Memory (RAM), SIM card, etc., or a memory which stores information even if the power is off, which can be selectively erased and provided with more data, and the example of such a memory is sometimes called as EPROM, etc. The memory 140 also may be a certain device of other type. The memory 140 includes a buffer memory 141 (sometimes called as buffer). The memory 140 may include an application/function storage section 142 which stores application programs and function programs or performs the operation procedure of the electronic device 1000 via the CPU 100

The memory 140 may further include a data storage section 143 which stores data such as contacts, digital data, pictures, sounds and/or any other data used by the electronic device. A drive program storage section 144 of the memory 140 may include various drive programs of the electronic device for performing the communication function and/or other functions (e.g., message transfer application, address book application, etc.) of the electronic device.

As illustrated in FIG. 10, the electronic device 1000 may further include a communication module 110, an input unit 120, an audio processing unit 130, a camera 150, a display 160 and a power supply 170.

The camera 150 captures image data and supplies the captured image data to the CPU 100 for a conventional usage, such as storage, transmission, etc. The power supply 170 supplies electric power to the electronic device 1000. The display 160 displays objects such as images and texts. The display may be, but not limited to, an LCD.

The communication module 110 is a transmitter/receiver 110 which transmits and receives signals via an antenna 111. The communication module (transmitter/receiver) 110 is coupled to the CPU 100, so as to provide an input signal and receive an output signal, which may be the same as the situation of conventional mobile communication terminal.

Based on different communication technologies, the same electronic device may be provided with a plurality of communication modules 110, such as cellular network module, Bluetooth module and/or wireless local area network (WLAN) module. The communication module (transmitter/receiver) 110 is further coupled to a speaker 131 and a microphone 132 via the audio processor 130, so as to provide an audio output via the speaker 131, and receive an audio input from the microphone 132, thereby performing the normal telecom function. The audio processor 130 may include any suitable buffer, decoder, amplifier, etc. In addition, the audio processor 130 is further coupled to the CPU 100, so as to locally record sound through the microphone 132, and play the locally stored sound through the speaker 131.

The preferred embodiments of the present invention are described as above with reference to the drawings. Many features and advantages of those embodiments are apparent from the detailed Specification, thus the accompanied claims intend to cover all such features and advantages of those embodiments which fall within the true spirit and scope thereof. In addition, since numerous modifications and changes are easily conceivable to a person skilled in the art, the embodiments of the present invention are not limited to the exact structures and operations as illustrated and described, but cover all suitable modifications and equivalents falling within the scope thereof.

It shall be understood that each of the parts of the present invention may be implemented by hardware, software, firmware, or combinations thereof. In the above embodiments, multiple steps or methods may be implemented by software or firmware stored in the memory and executed by an appropriate instruction executing system. For example, if the implementation uses hardware, it may be realized by any one of the following technologies known in the art or combinations thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

Any process, method or block in the flowchart or described in other manners herein may be understood as being indicative of including one or more modules, segments or parts for realizing the codes of executable instructions of the steps in specific logic functions or processes, and that the scope of the preferred embodiments of the present invention include other implementations, wherein the functions may be executed in manners different from those shown or discussed (e.g., according to the related functions in a substantially simultaneous manner or in a reverse order), which shall be understood by a person skilled in the art.

The logics and/or steps shown in the flowchart or described in other ways herein may be, for example, understood as a sequencing list of executable instructions for realizing logic functions, which may be implemented in any computer readable medium, for use by an instruction executing system, apparatus or device (such as a system based on a computer, a system including a processor, or other systems capable of extracting instructions from an instruction executing system, apparatus or device and executing the instructions), or for use in combination with the instruction executing system, apparatus or device.

The above literal descriptions and drawings show various features of the present invention. It shall be understood that a person of ordinary skill in the art may prepare suitable computer codes to carry out each of the steps and processes described above and illustrated in the drawings. It shall also be understood that the above-described terminals, computers, servers, and networks, etc. may be any type, and the computer codes may be prepared according to the disclosure contained herein to carry out the present invention by using the apparatus.

Particular embodiments of the present invention have been disclosed herein. A person skilled in the art will readily recognize that the present invention is applicable in other environments. In practice, there exist many embodiments and implementations. The appended claims are by no means intended to limit the scope of the present invention to the above particular embodiments. Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is included in that claim.

Although a particular preferred embodiment or embodiments have been shown and the present invention has been described, it is obvious that equivalent modifications and variants are conceivable to a person skilled in the art in reading and understanding the description and drawings. Especially for various functions executed by the above elements (parts, components, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. A proximity sensing device, comprising:
a window;
a signal transmitting element, integrated at an inner side of the window, to transmit an optical signal to an outer side of the window; and
a signal sensing element, integrated at the inner side of the window and disposed side by side with the signal transmitting element, to sense an object at the outer side of the window by receiving the optical signal reflected by the object.

2. The proximity sensing device according to claim 1, wherein pads are encapsulated on the surfaces of the signal transmitting element and the signal sensing element connected to the window, and the signal transmitting element and the signal sensing element are bonded on the inner surface of the window by using the pads.

3. The proximity sensing device according to claim 1, wherein the signal transmitting element and the signal sensing element have pins integrated to the window, respectively, and signal lines of the signal transmitting element and the signal sensing element are connected to the window via the pins.

4. The proximity sensing device according to claim 3, wherein the pins are welded to the surface of the window using an Anisotropic Conductive Film (ACF) bonding technology.

5. The proximity sensing device according to claim 3, wherein the window is integrated with a Sensor On Lens (SOL), and the signal lines of the signal transmitting element and the signal sensing element are connected to the SOL via the pins.

6. The proximity sensing device according to claim 1, further comprising:
a printed circuit board, disposed at sides of the signal transmitting element and the signal sensing element opposite the window.

7. The proximity sensing device according to claim 6, wherein signal lines of the signal transmitting element and the signal sensing element are connected to the printed circuit board.

8. An electronic device, comprising the proximity sensing device according to claim 1.

9. An electronic device, comprising the proximity sensing device according to claim 2.

10. An electronic device, comprising the proximity sensing device according to claim 3.

11. An electronic device, comprising the proximity sensing device according to claim 4.

12. An electronic device, comprising the proximity sensing device according to claim 5.

13. An electronic device, comprising the proximity sensing device according to claim 6.

14. An electronic device, comprising the proximity sensing device according to claim 7.

15. A method for manufacturing a proximity sensing device, comprising:
disposing a window;
integrating a signal transmitting element at an inner side of the window, the signal transmitting element transmitting an optical signal to an outer side of the window; and
integrating a signal sensing element at the inner side of the window and disposing the signal sensing element side by side with the signal transmitting element, the signal sensing element sensing an object at the outer side of the window by receiving the optical signal reflected by the object.

16. The method for manufacturing a proximity sensing device according to claim 15, further comprising:
encapsulating pads on the surfaces of the signal transmitting element and the signal sensing element connected to the window, and bonding the signal transmitting element and the signal sensing element on the inner surface of the window by using the pads.

17. The method for manufacturing a proximity sensing device according to claim 15, wherein the signal transmitting element and the signal sensing element have pins integrated to the window, respectively, and signal lines of the signal transmitting element and the signal sensing element are connected to the window via the pins.

18. The method for manufacturing a proximity sensing device according to claim 17, wherein the window is integrated with a Sensor On Lens (SOL), the method further comprising:
welding the pins to the surface of the window using an Anisotropic Conductive Film (ACF) bonding technology, wherein the signal lines of the signal transmitting element and the signal sensing element are connected to the SOL via the pins.
